(19) United States
(12) Patent Application Publication
(10) Pub. No.: US 2015/0154804 A1
(43) Pub. Date: Jun. 4, 2015

(54) Systems and Methods for Augmented-Reality Interactions

(71) Applicant: Tencent Technology (Shenzhen) Company Limited, Shenzhen (CN)

(72) Inventor: Yulong Wang, Shenzhen (CN)

(21) Appl. No.: 14/620,897

(22) Filed: Feb. 12, 2015

Related U.S. Application Data
(63) Continuation of application No. PCT/CN2014/080338, filed on Jun. 19, 2014.

(30) Foreign Application Priority Data
Jun. 24, 2013 (CN) 201310253772.1

(51) Int. Cl. G06T 19/00; G06K 9/00

(52) U.S. Cl. CPC G06T 19/006; G06K 9/00234; G06T 2215/16; G06T 2207/30244

(57) ABSTRACT

Systems and methods are provided for augmented-reality interactions based on face detection. For example, a video stream is captured; one or more first image frames are acquired from the video stream; face-detection is performed on the one or more first image frames to obtain facial image data of the one or more first image frames; a camera-calibrated parameter matrix and an affine-transformation matrix corresponding to user hand gestures are acquired; and a virtual scene is generated based on at least information associated with calculation using the facial image data in combination with the parameter matrix and the affine-transformation matrix.

### CROSS-REFERENCES TO RELATED APPLICATIONS

This application claims priority to Chinese Patent Application No. 201310253772.1, filed Jun. 24, 2013, incorporated by reference herein for all purposes.

### BACKGROUND OF THE INVENTION

Certain embodiments of the present invention are directed to computer technology. More particularly, some embodiments of the invention provide systems and methods for information processing. Merely by way of example, some embodiments of the invention have been applied to images. But it would be recognized that the invention has a much broader range of applicability.

Augmented reality (AR) is also called mixed reality, which utilizes computer technology to apply virtual data to the real world so that a real environment and virtual objects are superimposed and exist in a same image or a same space. AR can have extensive applications in different areas, such as medication, military, aviation, shipping, entertainment, gaming and education. For instance, AR games allow players in different parts of the world to enter a same natural scene for online battling under virtual substitute identities. AR is a technology “augmenting” a real scene with virtual objects. Compared with virtual-reality technology, AR has the advantages of a higher degree of reality and a smaller workload for modeling.

Conventional AR interaction methods include those based on a hardware sensing system and/or image processing technology. For example, the method based on the hardware sensing system often utilizes identification sensors or tracking sensors. As an example, a user needs to wear a sensor-mounted helmet which may capture some limb actions or trace the moving trend of limbs, calculate the gesture information of limbs and render a virtual scene with the gesture information. However, this method depends on the performance of hardware sensors, and is often not suitable for mobile arrangement. In addition, the cost associated with this method is high. In another example, the method based on image processing technology usually depends on a pretreated local database (e.g., a sorter). The performance of the sorter often depends on the size of training samples and image quality. The larger the training samples are, the better the identification is. However, the higher the accuracy of the sorter, the heavier the calculation workload will be during the identification process, which results in a longer time. Therefore, the AR interactions based on image processing technology often causes delays, particularly for mobile equipment.

Hence it is highly desirable to improve the techniques for augmented-reality interactions.

### BRIEF SUMMARY OF THE INVENTION

According to one embodiment, a method is provided for augmented-reality interactions based on face detection. For example, a video stream is captured; one or more first image frames are acquired from the video stream; face-detection is performed on the one or more first image frames to obtain facial image data of the one or more first image frames; a camera-calibrated parameter matrix and an affine-transformation matrix corresponding to user hand gestures are acquired; and a virtual scene is generated based on at least information associated with calculation using the facial image data in combination with the parameter matrix and the affine-transformation matrix.

According to another embodiment, a system for augmented-reality interactions includes: a video-stream-capturing module, an image-frame-capturing module, a face-detection module, a matrix-acquisition module and a scene-rendering module. The video-stream-capturing module is configured to capture a video stream. The image-frame-capturing module is configured to capture one or more image frames from the video stream. The face-detection module is configured to perform face-detection on the one or more first image frames to obtain facial image data of the one or more first image frames. The matrix-acquisition module is configured to acquire a camera-calibrated parameter matrix and an affine-transformation matrix corresponding to user hand gestures. The scene-rendering module is configured to generate a virtual scene based on at least information associated with calculation using the facial image data in combination with the parameter matrix and the affine-transformation matrix.

According to yet another embodiment, a non-transitory computer readable storage medium includes programming instructions for augmented-reality interactions. The programming instructions are configured to cause one or more data processors to execute certain operations. For example, a video stream is captured; one or more first image frames are acquired from the video stream; face-detection is performed on the one or more first image frames to obtain facial image data of the one or more first image frames; a camera-calibrated parameter matrix and an affine-transformation matrix corresponding to user hand gestures are acquired; and a virtual scene is generated based on at least information associated with calculation using the facial image data in combination with the parameter matrix and the affine-transformation matrix.

For example, the systems and methods described herein can be configured to not rely on any hardware sensor or any local database so as to achieve low cost and fast responding augmented-reality interactions, particularly suitable for mobile terminals. In another example, the systems and methods described herein can be configured to combine facial image data, a parameter matrix and an affine-transformation matrix to control a virtual model for simplicity, scalability and high efficiency, and perform format conversion and/or deflation on images before face detection to reduce workload and improve processing efficiency. In yet another example, the systems and methods described herein can be configured to divide a captured face area and select a benchmark area to reduce calculation workload and further improve the processing efficiency.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for augmented-reality interactions based on face detection according to one embodiment of the present invention.

FIG. 2 is a simplified diagram showing a process for performing face-detection on image frames to obtain facial image data as part of the method as shown in FIG. 1 according to one embodiment of the present invention.

FIG. 3 is a simplified diagram showing a three-eye-five-section-division method according to one embodiment of the present invention.

FIG. 4 is a simplified diagram showing a process for generating a virtual scene as part of the method as shown in FIG. 1 according to one embodiment of the present invention.

FIG. 5 is a simplified diagram showing a system for augmented-reality interactions based on face detection according to one embodiment of the present invention.

FIG. 6 is a simplified diagram showing a system for augmented-reality interactions based on face detection according to another embodiment of the present invention.

FIG. 7 is a simplified diagram showing a face-detection module as part of the system as shown in FIG. 5 according to one embodiment of the present invention.

FIG. 8 is a simplified diagram showing a system for augmented-reality interactions based on face detection according to yet another embodiment of the present invention.

FIG. 9 is a simplified diagram showing a scene-rendering module as part of the system as shown in FIG. 5 according to one embodiment of the present invention.

### DETAILED DESCRIPTION OF THE INVENTION

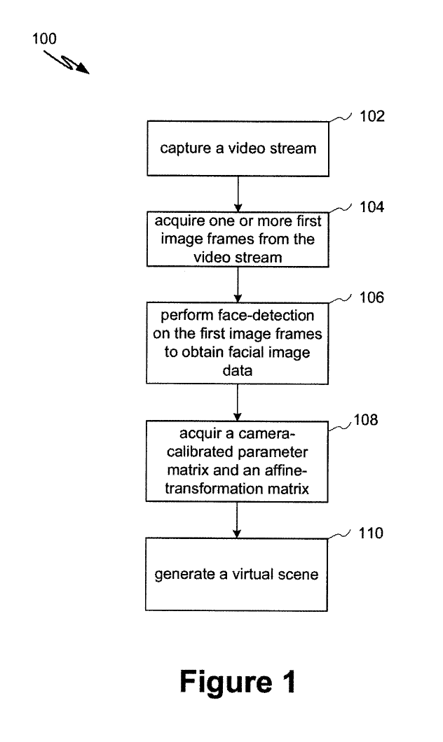

FIG. 1 is a simplified diagram showing a method for augmented-reality interactions based on face detection according to one embodiment of the present invention. This diagram is merely an example, which should not unduly limit the scope of the claims. One of ordinary skill in the art would recognize many variations, alternatives, and modifications. The method 100 includes at least the processes 102-110.

According to one embodiment, the process 102 includes: capturing a video stream. For example, the video stream is captured through a camera (e.g., an image sensor) mounted on a terminal and includes image frames captured by the camera. As an example, the terminal includes a smart phone, a tablet computer, a laptop, a desktop, or other suitable devices. In another example, the process 104 includes: acquiring one or more first image frames from the video stream.

According to another embodiment, the process 106 includes: performing face-detection on the one or more first image frames to obtain facial image data of the one or more first image frames. As an example, face detection is performed for each image frame to obtain facial images. The facial images are two-dimensional images, where facial image data of each image frame includes pixels of the two-dimensional images. For example, before the process 106, format conversion and/or deflation are performed on each image frame after the image frames are acquired. The images captured by the cameras on different terminals may have different data formats, and the images retuned by the operating system may not be compatible with the image processing engine. Thus, the images are converted into a format which can be processed by the image processing engine, in some embodiments. The images captured by the cameras are normally color images which have multiple channels. For example, a pixel of an image is represented by four channels—RGBA. As an example, processing each channel is often time-consuming. Thus, deflation is performed on each image frame to reduce the multiple channels to a single channel, and the subsequent face detection process deals with the single channel instead of the multiple channels, so as to improve the efficiency of image processing, in certain embodiments.

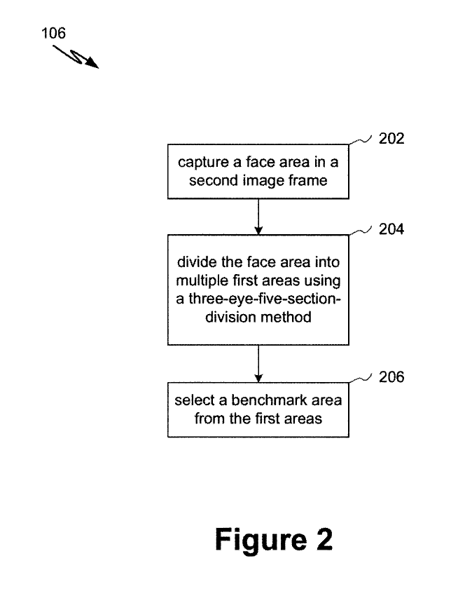

FIG. 2 is a simplified diagram showing the process 106 for performing face-detection on the one or more first image frames to obtain facial image data of the one or more first image frames according to one embodiment of the present invention. This diagram is merely an example, which should not unduly limit the scope of the claims. One of ordinary skill in the art would recognize many variations, alternatives, and modifications. The process 106 includes at least the processes 202-206.

According to one embodiment, the process 202 includes: capturing a face area in a second image frame, the second image frame being included in the one or more first image frames. For example, a rectangular face area in the second image frame is captured based on at least information associated with at least one of skin colors, templates and morphology information. In one example, the rectangular face area is captured based on skin colors. Skin colors of human beings are distributed within a range in a color space. Different skin colors reflect different color strengths. Under a certain illuminating condition, skin colors are normalized to satisfy a Gaussian distribution. The image is divided into the skin area and the non-skin area, and the skin area is processed based on boundaries and areas to obtain the face area. In another example, the rectangular face area is captured based on templates. A sample facial image is cropped based on a certain ratio, and a partial facial image that reflects a face mode is obtained. Then, the face area is detected based on skin color. In yet another example, the rectangular face area is captured based on morphology information. An approximate area of face is captured first. Accurate positions of eyes, mouth, etc. are determined based on a morphological-model-detection algorithm according to the shape and distribution of various organs in the facial image to finally obtain the face area. According to another embodiment, the process 204 includes: dividing the face area into multiple first areas using a three-eye-five-section-division method.

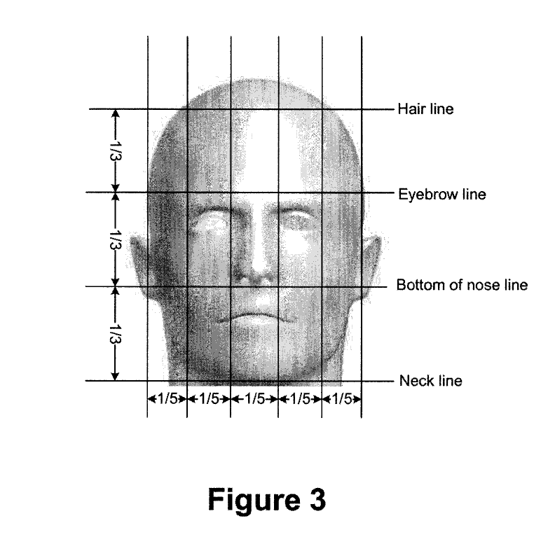

FIG. 3 is a simplified diagram showing a three-eye-five-section-division method according to one embodiment of the present invention. This diagram is merely an example, which should not unduly limit the scope of the claims. One of ordinary skill in the art would recognize many variations, alternatives, and modifications. According to one embodiment, after a face area is acquired, it is possible to divide the face area by the three-eye-five-section-division method to obtain a plurality of parts.

Referring back to FIG. 2, the process 206 includes: selecting a benchmark area from the first areas, in some embodiments. For example, the division of the face area generates many parts, so that obtaining facial-spatial-gesture information over the entire face area often results in a substantial calculation workload. As an example, a small rectangular area is selected for processing after the division.

Referring back to FIG. 1, the process 108 includes: acquiring a camera-calibrated parameter matrix and an affine-transformation matrix corresponding to user hand gestures, in certain embodiments. For example, the parameter matrix is determined during calibration of a camera and therefore such a parameter matrix can be directly obtained. In another example, the affine-transformation matrix can be calculated according to a user's hand gestures. For a mobile terminal with a touch screen, the user's finger sliding or tabbing on the touch screen is deemed as hand gestures, where slide gestures further include sliding leftward, rightward, upward and downward, rotation and other complicated slides, in some embodiments. For some basic hand gestures, such as tabbing and sliding leftward, rightward, upward and downward, an application programming interface (API) provided by the operating system of the mobile terminal is used to calculate and obtain the corresponding affine-transformation matrix, in certain embodiments. For some complicated hand gestures, changes can be made to the affine-transformation matrix for the basic hand gestures to obtain a corresponding affine-transformation matrix.

In one embodiment, a sensor is used to detect the facial-gesture information and an affine-transformation matrix is obtained according to the facial-gesture information. For example, a sensor is used to detect the facial-gesture information which includes three-dimensional facial data, such as spatial coordinates, depth data, rotation or displacement. In another example, a projection matrix and a model visual matrix are established for rendering a virtual scene. In yet another example, the projection matrix maps between the coordinates of a fixed spatial point and the coordinates of a pixel. In yet another example, the model visual matrix indicates changes of a model (e.g., displacement, zoom-in/out, rotation, etc.). In yet another example, the facial-gesture information detected by the sensor is converted into a model visual matrix which can control some simple movements of the model. The larger a depth value in the perspective transformation, the smaller the model appears, in some embodiments. The smaller the depth value, the larger the model appears. For example, the facial-gesture information detected by the sensor may be used to calculate and obtain the affine-transformation matrix to affect the virtual model during the rendering process of the virtual scene. The use of the sensor to detect facial-gesture information for obtaining the affine-transformation matrix yields a high processing speed, in certain embodiments.

In another embodiment, the process 110 includes: generating a virtual scene based on at least information associated with calculation using the facial image data in combination with the parameter matrix and the affine-transformation matrix. For example, the parameter matrix is calculated for the virtual-scene-rendering model:

M′=M×M,

where M′ represents the parameter matrix associated with the virtual-scene-rendering model, M represents the camera-calibrated parameter matrix; and Mₛ represents the affine-transformation matrix corresponding to user's hand gestures. As an example, the calculated transformation matrix imports and controls the virtual model during the rendering process of the virtual scene.

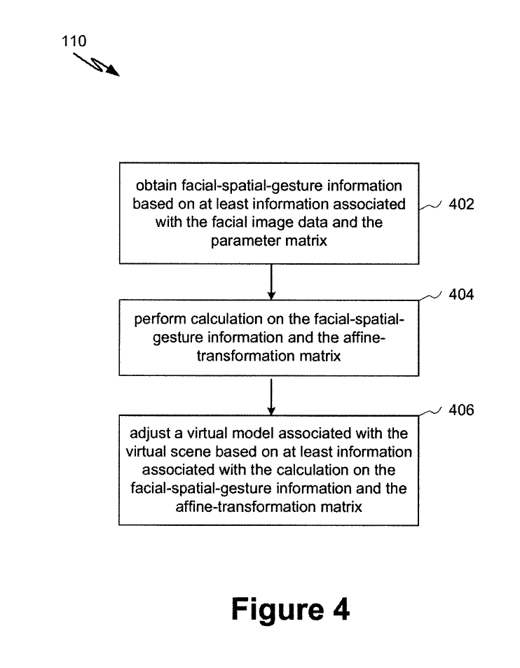

FIG. 4 is a simplified diagram showing the process 110 for generating a virtual scene based on at least information associated with calculation using the facial image data in combination with the parameter matrix and the affine-transformation matrix according to one embodiment of the present invention. This diagram is merely an example, which should not unduly limit the scope of the claims. One of ordinary skill in the art would recognize many variations, alternatives, and modifications. The process 100 includes at least the processes 402-406.

According to one embodiment, the process 402 includes: obtaining facial-spatial-gesture information based on at least information associated with the facial image data and the parameter matrix. For example, calculation is performed based on the facial image data acquired within the benchmark area and the parameter matrix to convert the two-dimensional image into three-dimensional facial-spatial-gesture information, including spatial coordinates, rotational degrees and depth data. In another example, the process 404 includes: performing calculation on the facial-spatial-gesture information and the affine-transformation matrix. In yet another example, during the process 402, the two-dimensional facial image data (e.g., two-dimensional pixels) are converted into the three-dimensional facial-spatial-gesture information (e.g., three-dimensional facial data). In yet another example, after the calculation on the three-dimensional facial information and the affine-transformation matrix, multiple operations (e.g., displacement, rotation and depth adjustment) are performed on the virtual model. That is, the affine-transformation matrix enables such operations as displacement, rotation and depth adjustment of the virtual model, in some embodiments. For example, the process 406 includes adjusting the virtual model associated with the virtual scene based on at least information associated with the calculation on the facial-spatial-gesture information and the affine-transformation matrix. In another example, after the calculation on the facial-spatial-gesture information and the affine-transformation matrix, the virtual model is controlled during rendering of the virtual scene (e.g., displacement, rotation and depth adjustment of the virtual model).

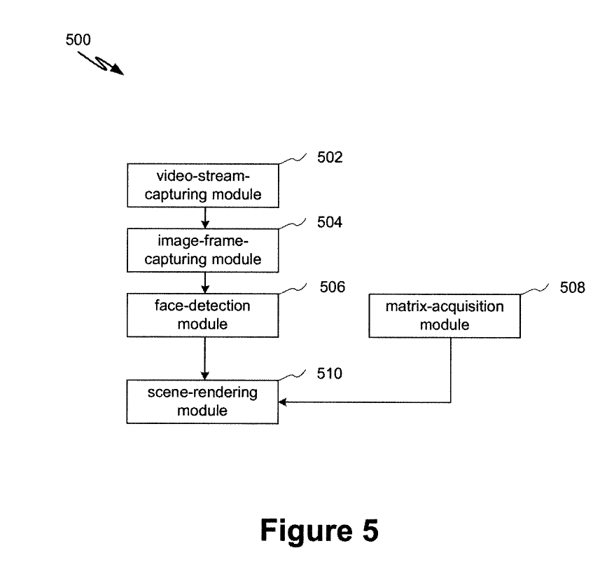

FIG. 5 is a simplified diagram showing a system for augmented-reality interactions based on face detection according to one embodiment of the present invention. This diagram is merely an example, which should not unduly limit the scope of the claims. One of ordinary skill in the art would recognize many variations, alternatives, and modifications. The system 500 includes: a video-stream-capturing module 502, an image-frame-capturing module 504, a face-detection module 506, a matrix-acquisition module 508 and a scene-rendering module 510.

According to one embodiment, the video-stream-capturing module 502 is configured to capture a video stream. For example, the image-frame-capturing module 504 is configured to capture one or more image frames from the video stream. In another example, the face-detection module 506 is configured to perform face-detection on the one or more first image frames to obtain facial image data of the one or more first image frames. In yet another example, the matrix-acquisition module 508 is configured to acquire a camera-calibrated parameter matrix and an affine-transformation matrix corresponding to user hand gestures. In yet another example, the scene-rendering module 510 is configured to generate a virtual scene based on at least information associated with calculation using the facial image data in combination with the parameter matrix and the affine-transformation matrix.

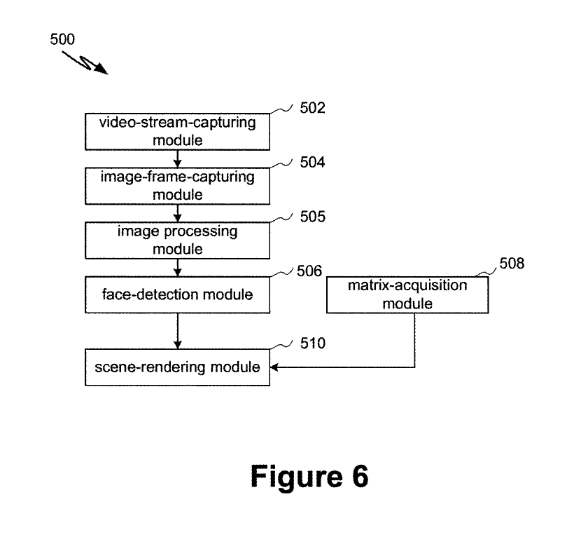

FIG. 6 is a simplified diagram showing the system 500 for augmented-reality interactions based on face detection according to another embodiment of the present invention. This diagram is merely an example, which should not unduly limit the scope of the claims. One of ordinary skill in the art would recognize many variations, alternatives, and modifications. The system 500 further includes an image processing module 505 configured to perform format conversion on the one or more first image frames.

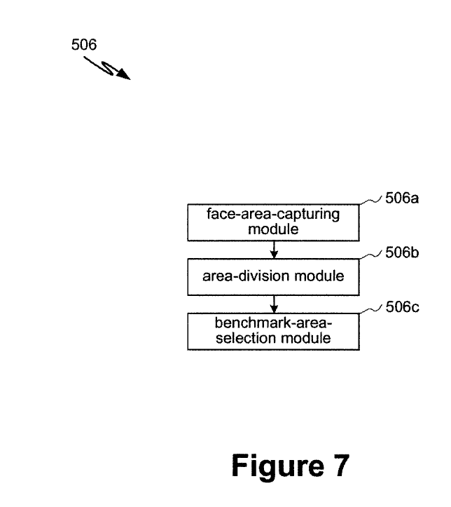

FIG. 7 is a simplified diagram showing the face-detection module 506 according to one embodiment of the present invention. This diagram is merely an example, which should not unduly limit the scope of the claims. One of ordinary skill in the art would recognize many variations, alternatives, and modifications. The face-detection module 506 includes: a face-area-capturing module 506a, an area-division module 506b, and a benchmark-area-selection module 506c.

According to one embodiment, the face-area-capturing module 506a is configured to capture a face area in a second image frame, the second image frame being included in the one or more first image frames. For example, the face-area-capturing module 506a captures a rectangular face area in each of the image frames based on skin color, templates and morphology information. In another example, the area-division module 506b is configured to divide the face area into multiple first areas using a three-eye-five-section-division method. In yet another example, the benchmark-area-selection module 506c is configured to select a benchmark area from the first areas. In yet another example, the parameter matrix is determined during calibration of a camera so that the parameter matrix can be directly acquired. As an example, the affine-transformation matrix can be obtained according to the user's hand gestures. For instance, the corresponding affine-transformation matrix can be calculated and acquired via an API provided by an operating system of a mobile terminal.

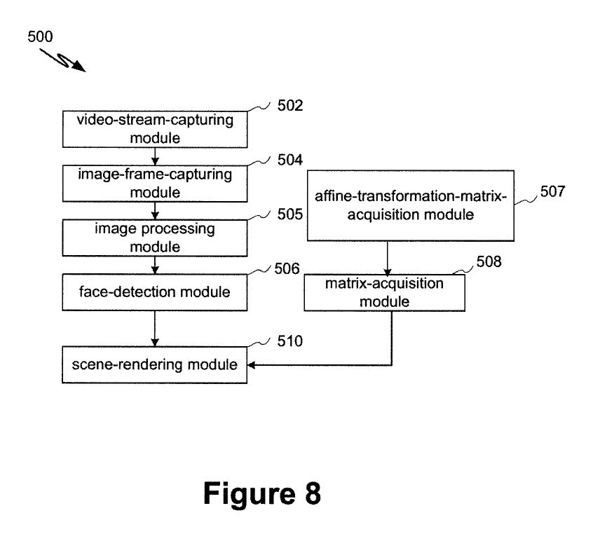

FIG. 8 is a simplified diagram showing the system 500 for augmented-reality interactions based on face detection according to yet another embodiment of the present invention. This diagram is merely an example, which should not unduly limit the scope of the claims. One of ordinary skill in the art would recognize many variations, alternatives, and modifications. The system 500 further includes an affine-transformation-matrix-acquisition module 507 configured to detect, using a sensor, facial-gesture information and obtain the affine-transformation matrix based on at least information associated with the facial-gesture information.

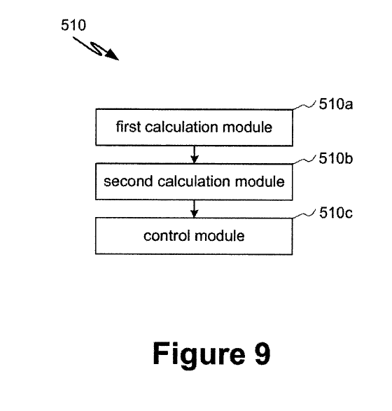

FIG. 9 is a simplified diagram showing the scene-rendering module 510 according to one embodiment of the present invention. This diagram is merely an example, which should not unduly limit the scope of the claims. One of ordinary skill in the art would recognize many variations, alternatives, and modifications. The scene-rendering module 510 includes: the first calculation module 510a, the second calculation module 510b, and the control module 510c.

According to one embodiment, the first calculation module 510a is configured to obtain facial-spatial-gesture information based on at least information associated with the facial image data and the parameter matrix. For example, the second calculation module 510b is configured to perform calculation on the facial-spatial-gesture information and the affine-transformation matrix. In another example, the control module 510c is configured to adjust a virtual model associated with the virtual scene based on at least information associated with the calculation on the facial-spatial-gesture information and the affine-transformation matrix.

According to one embodiment, a method is provided for augmented-reality interactions based on face detection. For example, a video stream is captured; one or more first image frames are acquired from the video stream; face-detection is performed on the one or more first image frames to obtain facial image data of the one or more first image frames; a camera-calibrated parameter matrix and an affine-transformation matrix corresponding to user hand gestures are acquired; and a virtual scene is generated based on at least information associated with calculation using the facial image data in combination with the parameter matrix and the affine-transformation matrix. For example, the method is implemented according to at least FIG. 1, FIG. 2, and/or FIG. 4.

According to another embodiment, a system for augmented-reality interactions includes: a video-stream-capturing module, an image-frame-capturing module, a face-detection module, a matrix-acquisition module and a scene-rendering module. The video-stream-capturing module is configured to capture a video stream. The image-frame-capturing module is configured to capture one or more image frames from the video stream. The face-detection module is configured to perform face-detection on the one or more first image frames to obtain facial image data of the one or more first image frames. The matrix-acquisition module is configured to acquire a camera-calibrated parameter matrix and an affine-transformation matrix corresponding to user hand gestures. The scene-rendering module is configured to generate a virtual scene based on at least information associated with calculation using the facial image data in combination with the parameter matrix and the affine-transformation matrix. For example, the system is implemented according to at least FIG. 5, FIG. 6, FIG. 7, FIG. 8, and/or FIG. 9.

According to yet another embodiment, a non-transitory computer readable storage medium includes programming instructions for augmented-reality interactions. The programming instructions are configured to cause one or more data processors to execute certain operations. For example, a video stream is captured; one or more first image frames are acquired from the video stream; face-detection is performed on the one or more first image frames to obtain facial image data of the one or more first image frames; a camera-calibrated parameter matrix and an affine-transformation matrix corresponding to user hand gestures are acquired; and a virtual scene is generated based on at least information associated with calculation using the facial image data in combination with the parameter matrix and the affine-transformation matrix. For example, the storage medium is implemented according to at least FIG. 1, FIG. 2, and/or FIG. 4.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A method for augmented-reality interactions, the method comprising:
capturing a video stream;
acquiring one or more first image frames from the video stream;
performing face-detection on the one or more first image frames to obtain facial image data of the one or more first image frames;
acquiring a camera-calibrated parameter matrix and an affine-transformation matrix corresponding to user hand gestures; and
generating a virtual scene based on at least information associated with calculation using the facial image data in combination with the parameter matrix and the affine-transformation matrix.

2. The method of claim 1, further comprising:
performing format conversion on the one or more first image frames.

3. The method of claim 1, further comprising:
performing deflation on the one or more first image frames.

4. The method of claim 1, wherein the perform face-detection on the one or more first image frames to obtain facial image data of the one or more first image frames includes:
capturing a face area in a second image frame, the second image frame being included in the one or more first image frames;
dividing the face area into multiple first areas using a three-eye-five-section-division method; and
selecting a benchmark area from the first areas.

5. The method of claim 4, wherein the capturing a face area in a second image frame includes:
capturing a rectangular face area in the second image frame based on at least information associated with at least one of skin colors, templates and morphology information.

6. The method of claim 1, further comprising:
detecting, using a sensor, facial-gesture information; and
obtaining the affine-transformation matrix based on at least information associated with the facial-gesture information.

7. The method of claim 1, wherein the generating a virtual scene based on at least information associated with calculation using the facial image data in combination with the parameter matrix and the affine-transformation matrix includes:
obtaining facial-spatial-gesture information based on at least information associated with the facial image data and the parameter matrix;
performing calculation on the facial-spatial-gesture information and the affine-transformation matrix; and
adjusting a virtual model associated with the virtual scene based on at least information associated with the calculation on the facial-spatial-gesture information and the affine-transformation matrix.

8. A system for augmented-reality interactions, the system comprising:
a video-stream-capturing module configured to capture a video stream;
an image-frame-capturing module configured to capture one or more image frames from the video stream;
a face-detection module configured to perform face-detection on the one or more first image frames to obtain facial image data of the one or more first image frames;
a matrix-acquisition module configured to acquire a camera-calibrated parameter matrix and an affine-transformation matrix corresponding to user hand gestures; and
a scene-rendering module configured to generate a virtual scene based on at least information associated with calculation using the facial image data in combination with the parameter matrix and the affine-transformation matrix.

9. The system of claim 8, further comprising:
an image processing module configured to perform format conversion on the one or more first image frames.

10. The system of claim 8, further comprising:
an image processing module configured to perform deflation on the one or more first image frames.

11. The system of claim 8, wherein the face-detection module includes:
a face-area-capturing module configured to capture a face area in a second image frame, the second image frame being included in the one or more first image frames;
an area-division module configured to divide the face area into multiple first areas using a three-eye-five-section-division method; and
a benchmark-area-selection module configured to select a benchmark area from the first areas.

12. The system of claim 11, wherein the face-area-capturing module is configured to capture a rectangular face area in the second image frame based on at least information associated with at least one of skin colors, templates and morphology information.

13. The system of claim 8, further comprising:
an affine-trans formation-matrix-acquisition module configured to detect, using a sensor, facial-gesture information and obtain the affine-transformation matrix based on at least information associated with the facial-gesture information.

14. The system of claim 8, wherein the scene-rendering module includes:
a first calculation module configured to obtain facial-spatial-gesture information based on at least information associated with the facial image data and the parameter matrix;
a second calculation module configured to perform calculation on the facial-spatial-gesture information and the affine-transformation matrix; and
a control module configured to adjust a virtual model associated with the virtual scene based on at least information associated with the calculation on the facial-spatial-gesture information and the affine-transformation matrix.

15. The system of claim 8, further comprising:
one or more data processors; and
a computer-readable storage medium;
wherein one or more of the video-stream-capturing module, the image-frame-capturing module, the face-detection module, the matrix-acquisition module and the scene-rendering module are stored in the storage medium and configured to be executed by the one or more data processors.

16. A non-transitory computer readable storage medium comprising programming instructions for augmented-reality interactions, the programming instructions configured to cause one or more data processors to execute operations comprising:
capturing a video stream;
acquiring one or more first image frames from the video stream;
performing face-detection on the one or more first image frames to obtain facial image data of the one or more first image frames;
acquiring a camera-calibrated parameter matrix and an affine-transformation matrix corresponding to user hand gestures; and
generating a virtual scene based on at least information associated with calculation using the facial image data in combination with the parameter matrix and the affine-transformation matrix.
